(19) United States
(12) Patent Application Publication
(10) Pub. No.: US 2021/0279830 A1
(43) Pub. Date: Sep. 9, 2021

(54) Commemorative System and Method

(71) Applicant: Isidro Gonzales, Albuquerque, NM (US)

(72) Inventor: Isidro Gonzales, Albuquerque, NM (US)

(21) Appl. No.: 17/193,345

(22) Filed: Mar. 5, 2021

Related U.S. Application Data
(60) Provisional application No. 62/986,823, filed on Mar. 9, 2020.

(51) Int. Cl. G06Q 50/18; G06F 16/955; G06K 7/14

(52) U.S. Cl. CPC G06Q 50/186; G06K 7/1417; G06F 16/9554

(57) ABSTRACT

A commemorative system for celebrating the life of and remembering people after death and method of use. The commemorative system allows a user to access an online interactive memorial platform. The online interactive memorial platform is set up and hosted remotely on a server. The online interactive memorial platform is customizable to provide create a unique digital memorial for an individual. Users can access the online interactive memorial platform using an App connected to the server via a network. The online interactive memorial platform is used to create a unique identifier specific to each unique digital memorial. The unique identifiers may be attached to gravestones, markers, or other physical memorials. To access the digital memorial, a user may scan the unique identifier with a smartphone using the App.

### CROSS-REFERENCE TO RELATED APPLICATION

The present application claims priority to, and the benefit of, U.S. Provisional Application No. 62/986,823, which was filed on Mar. 9, 2020 and is incorporated herein by reference in its entirety.

### FIELD OF THE INVENTION

The present invention generally relates to a memorial for decedents, and more specifically to a system for celebrating the life of and remembering people after death. Accordingly, the present specification makes specific reference thereto. However, it is to be appreciated that aspects of the present invention are also equally amenable to other like applications, devices and methods of manufacture.

### BACKGROUND OF THE INVENTION

The death of a family member, friend, or loved one can be extremely overwhelming. Remembering those individuals who have passed away can be difficult, especially with the passing of time. Friends and family may be unable to deliver messages and obtain information about the decedent prior to burial. Additionally, these individuals are easily forgotten after the burial or internment.

It is common to want to make memorial statements or donations on behalf of the deceased. Ceremonies often include pictorial displays such as photographs or videos of the loved one as a way to remember and honor the deceased. However, these displays are limited to the funeral or memorial service. Once the funeral is over, there is no easy way to continue celebrating the life or remembering the decedent's life.

Gravestones, memorials, and the like, typically have text and documents to explain who the deceased individual was and when he/she died. These sites do not have a large amount of space to provide any details about the deceased individual. People may fear that their loved ones may become forgotten with a simple name and date to indicate their life. Being able to see or hear what the deceased individual looked and sounded like may provide comfort for grieving friends and family. Additionally, the ability to view messages from others about the loved one can be comforting.

Accordingly, there is a great need for a way to provide mourners with a way to easily remember and relate to a deceased family member or friend. There is also a need for a way for individuals to express a heartfelt message or share a story about the recently deceased for access later at any time. Similarly, there is a need for a platform for individuals to access messages, pictures, or videos of the decedent whenever they want. There is also a need for a way for individuals to make a contribution on behalf of a decedent. Further, there is a need for a way to view how a deceased individual fits into a family.

In this manner, the improved commemorative system of the present invention accomplishes all of the forgoing objectives, thereby providing an easy solution for users to display love and friendship in the event of the death of a loved one. A primary feature of the present invention is a platform that is accessible to family members, loved ones, and other mourners related to the decedent. The present invention allows users to share stories, pictures, or videos that celebrate the life of the decedent. Finally, the improved commemorative system of the present invention is capable of allowing the memory of a loved one to continue and even evolve long after their death.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a commemorative system. The commemorative system is accessible via a camera-equipped mobile electronic device. The commemorative system is configured to memorialize a person in a platform that is remotely accessible over the Internet. The commemorative system provides users access to an online digital memorial platform from a remote location, such as a grave site or other place of internment.

The commemorative system comprises a server. The server comprises at least one processor and an online memorial platform. The server further comprises a memory. The memory comprises a non-transitory computer-readable medium comprising a set of software instructions. A mobile application is hosted on the camera-equipped mobile electronic device and is used to connect to and access the online memorial platform via a network.

The online memorial platform is configured to host a digital memorial created by a user to memorialize a person. The digital memorial is interactive. The online memorial platform is further configured to generate a unique identifier specific to the digital memorial. The unique identifier may be a QR code. A user can access the digital memorial remotely with the camera-equipped mobile electronic device.

The commemorative system further comprises a remote platform access component. The remote platform access component is configured to display the unique identifier at the grave site or other place of internment. The user can then scan the unique identifier the camera-equipped mobile electronic device to access and interact with the digital memorial.

When executed by the at least one processor, the set of software instructions is used to configure the digital memorial. The digital memorial may comprise a biographical component. The biographical component is configured to provide biographical information related to the person being memorialized. The digital memorial may further comprise at least one visual media upload component. The at least one visual media upload component allows the user to upload visual media to the digital memorial. The digital memorial may further comprise an audio upload component. The audio upload component allows the user to upload audio media to the digital memorial.

The digital memorial may further comprise a family tree component. The family tree component provides a diagram to illustrate various relationships with the person being memorialized. The digital memorial may further comprise at least one messaging component. The at least one messaging component is configured to allow users to leave and view comments and messages. The digital memorial may further comprise a social media linking component. The social media linking component allows users to access social media platforms of the person being memorialized.

The digital memorial may further comprise a visitor log component. The visitor log component is configured to provide a record of users that access the digital memorial. The digital memorial may further comprise a donation linking component. The donation linking component is configured to allow users to make a donation on behalf of the person being memorialized. The digital memorial may further comprise a viewing component. The viewing component is configured to allow users to access and view any uploaded visual or audio media uploaded to the digital memorial.

The subject matter disclosed and claimed herein, in another embodiment thereof, comprises a method of memorializing a person on an interactive online memorial platform. The online memorial platform is accessible via a camera-equipped mobile electronic device that connects to the online memorial platform over a network. The method comprises creating a digital memorial on the interactive online memorial platform.

Next, a unique identifier is generated specific to the digital memorial. The unique identifier may be a QR code that can be integrated into a remote platform access component that is positional at a grave site or other place of internment. Then the unique identifier is scanned using the camera-equipped mobile electronic device to interact with the digital memorial. Once accessed, the user can access uploaded content related to the memorialized person hosted on the digital memorial. The user can also upload content related to the memorialized person to the digital memorial.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an exemplary system environment of one embodiment of a commemorative system of the present invention for facilitating an interactive memorial platform in accordance with the disclosed architecture.

FIG. 2 illustrates an overhead view of a remote platform access component of the commemorative system of the present invention in accordance with the disclosed architecture.

FIG. 3 illustrates a front view of the remote platform access component of the present invention attached to a gravestone in accordance with the disclosed architecture.

FIG. 4 illustrates a perspective view of the remote platform access component of the present invention attached to a grave marker in accordance with the disclosed architecture.

FIG. 5 illustrates a perspective view of a unique identifier of the remote platform access component of the present invention attached to a burial urn in accordance with the disclosed architecture.

FIG. 6 illustrates a perspective view of a user scanning the remote platform access component of the present invention to access the interactive memorial platform in accordance with the disclosed architecture.

FIG. 7 illustrates a diagrammatic view of the interactive memorial platform of the present invention in accordance with the disclosed architecture.

FIG. 8 illustrates a flowchart of a computer implemented method of using the commemorative system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, provides memorials and gravesites with a scannable QR code capable of instantly displaying a profile of an individual buried at the site via a smartphone application, and displays a biography, family tree, photos, videos, blog posts, and more once the QR code is scanned. The device also allows deceased individuals to be remembered as he/she was in good health and happy times and memorializes an individual for a long period of time, ensuring visitors are able to learn about people buried in specific areas. Further, the device can be linked to other family member profiles using the application and code.

The commemorative system comprises a biographical mobile application for integration with tombstones. A mobile application allows a user to upload a biography, as well as photos, videos, blog posts, family history/family tree etc. The application then generates a unique barcode for each user and said barcode can be integrated into the tombstone of the user. Each code can be protected by a metal covering to prevent damage over a long period of time. Once deceased, the barcode on the tombstone of the user can be scanned by other family members who have the application. This application would allow future generations to learn about their deceased ancestors in their own words via a mobile app. People can be forever memorialized and never forgotten.

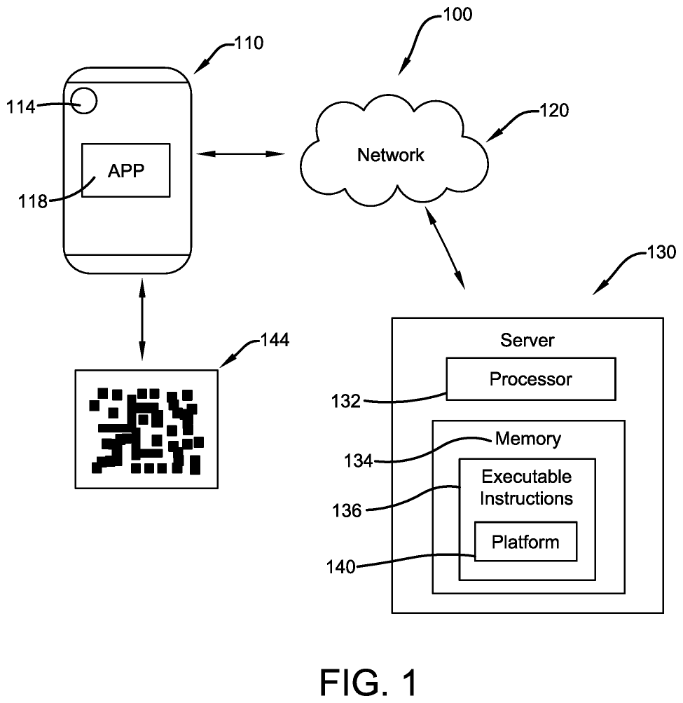

Referring initially to the drawings, FIG. 1 illustrates a commemorative system 100. The commemorative system 100 is accessible via a camera-equipped mobile electronic device 110 using a mobile application 118. The mobile application allows the camera-equipped mobile electronic device 110 to perform methods of the present technology when executed. The camera-equipped mobile electronic device 110 comprises a camera 114 and may be a mobile electronic device or other internet connectable user input, such as a smart phone, an electronic pad, a computer, a smart watch, a digital assistant, or any other internet connected communication device. The commemorative system 100 is configured to memorialize a person in a platform that is remotely accessible over the Internet. The commemorative system 100 provides access to an online memorial from a remote location, such as a grave site or other place of internment.

The commemorative system 100 comprises a server 130. The server 130 comprises at least one processor 132 and a memory 134. The memory 134 comprises a non-transitory computer-readable medium comprising a set of software instructions 136. The set of software instructions 136 comprises an online interactive memorial platform 140 stored on the server 130 in the memory 134. The server 130 is operatively connectable to the mobile electronic devices 110 via a communications network 120. The communications network 120 may be any of a number of private or public communications mechanisms such as the Internet, a local intranet, a Personal Area Network, a Local Area Network, a Wide Area Network, a Virtual Private Network, or the like. When one of the mobile electronic devices 110 is connected to the server 130 via the network 120, the online interactive memorial platform 140 allows the server 130 to perform methods of the present technology when executed by the processor 132.

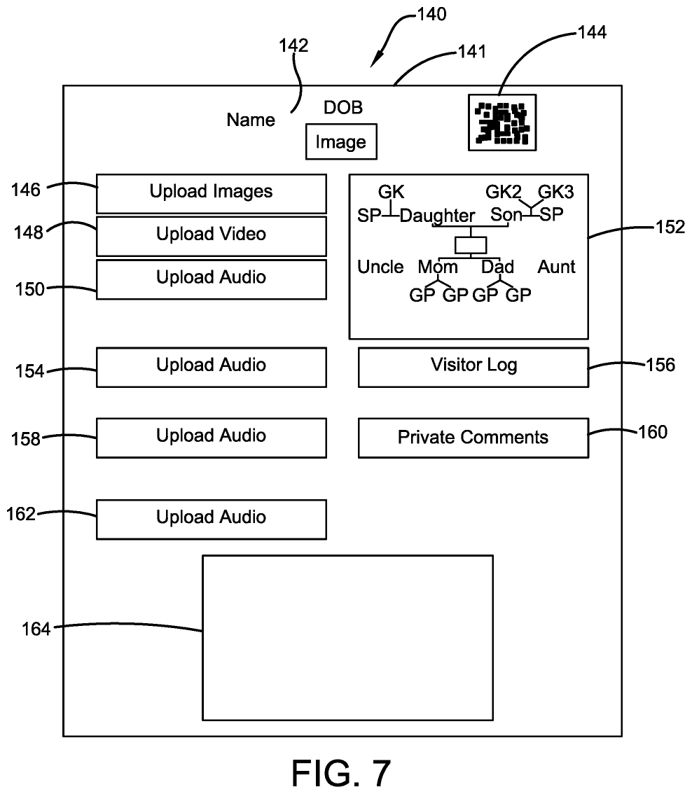

As illustrated in FIG. 7, the online memorial platform 140 is configured to create and host a digital memorial 141 to memorialize a person. The digital memorial 141 is interactive. The online memorial platform 140 is further configured to generate a unique identifier 144 specific to each digital memorial 141. The unique identifier 144 may be a QR code. A user can access the digital memorial 141 remotely with the camera-equipped mobile electronic device 110.

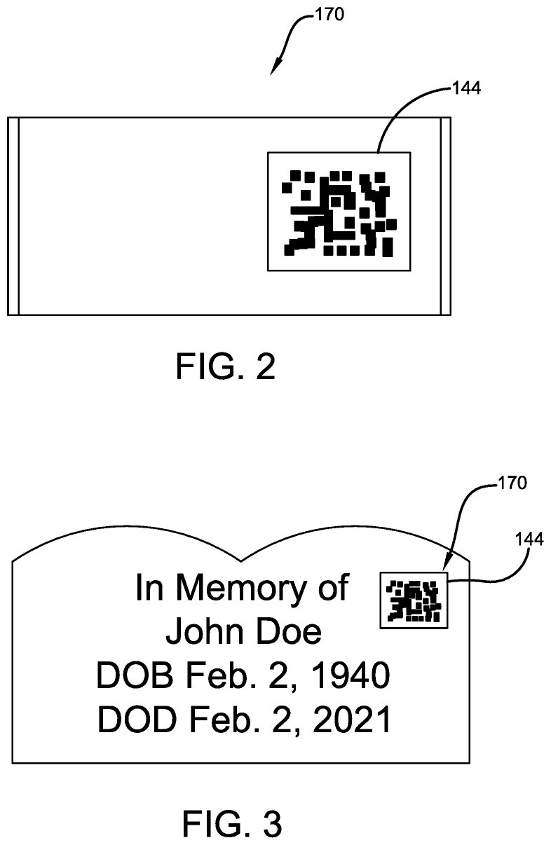

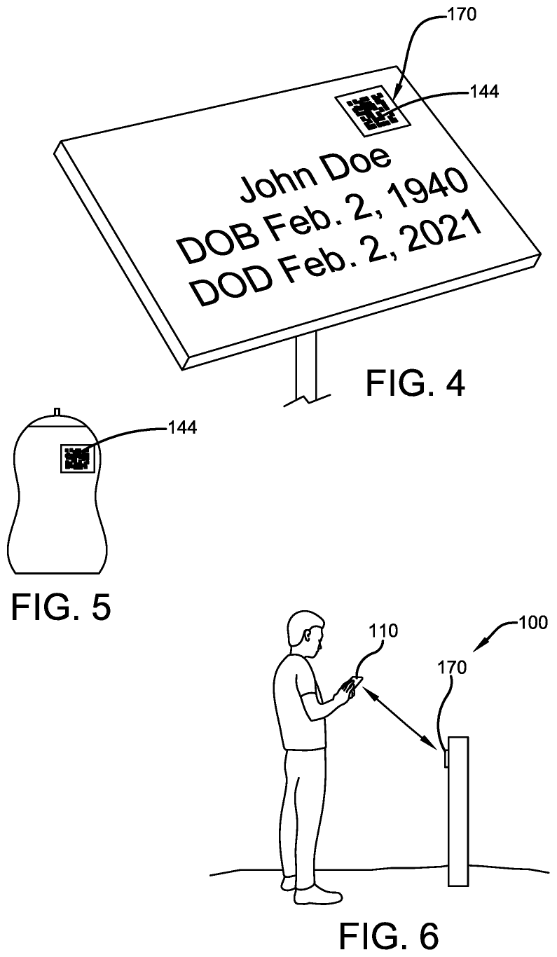

As illustrated in FIG. 2, the commemorative system 100 may further comprises a remote platform access component 170. The remote platform access component 170 is configured to display the unique identifier 144 at the grave site or other place of internment as illustrated in FIGS. 3-5. The remote platform access component 170 may be a glass, plastic, or metal case, bracket, holder, or the like. The user can then scan the unique identifier 144 with the camera 114 of the camera-equipped mobile electronic device 110 to access and interact with the digital memorial 141 as illustrated in FIG. 6. The unique identifier 144 may be retained by the remote platform access component 170 and attached to a tombstone, grave marker, urn, or other form of internment, or may be used in a print or electronic obituary without the remote platform access component 170.

When executed by the at least one processor 132, the online interactive memorial platform 140 is used to generate the digital memorial 141. As illustrated in FIG. 7, the digital memorial 141 may comprise a biographical component 142. The biographical component 142 is configured to provide biographical information related to the person being memorialized. The biographical component 142 typically includes biographical life details and imagery related to the life of the memorialized person.

The digital memorial 141 may further comprise at least one visual media upload component. The at least one visual media upload component may comprise a digital image upload component 146. The digital image upload component 146 allows the host and visitors accessing the digital memorial 141 to upload and share pictures on the digital memorial 141. The at least one visual media upload component may further comprise a video upload component 148. The video upload component 148 allows the host and visitors accessing the digital memorial 141 to upload and share video on the digital memorial 141. The digital memorial 141 may further comprise an audio upload component 150. The audio upload component 150 allows the user to upload and share audio media to the digital memorial 141.

The digital memorial 141 may further comprise a family tree component 152. The family tree component 152 provides a diagram to illustrate various relationships with the person being memorialized. The family tree component 152 may be used to link to additional digital memorials hosted on the online interactive memorial platform 140 by clicking on a name. The digital memorial 141 may further comprise a social media linking component 154. The social media linking component 154 allows users to access a variety of social media platforms of the person being memorialized.

The digital memorial 141 may further comprise at least one messaging component. The at least one messaging component is configured to allow users to leave and view comments and messages. The at least one messaging component may comprise a public messaging component 158 and a private messaging component 160. The public messaging component 158 may be configured to upload and store messages, blog entries, suggestions, or host an interactive chat room and is accessible by anyone accessing the digital memorial 141. The private messaging component 160 may be similarly configured but is only accessible by password or other unique identifier.

The digital memorial 141 may further comprise a visitor log component 156. The visitor log component 156 is configured to provide a record of users that access the digital memorial 141. The digital memorial 141 may further comprise a donation linking component 162. The donation linking component 162 is configured to allow users to make a donation on behalf of the person being memorialized. The digital memorial 141 may further comprise a viewing component 164. The viewing component 164 is configured to allow users to access and view any uploaded visual or audio media uploaded to the digital memorial 141.

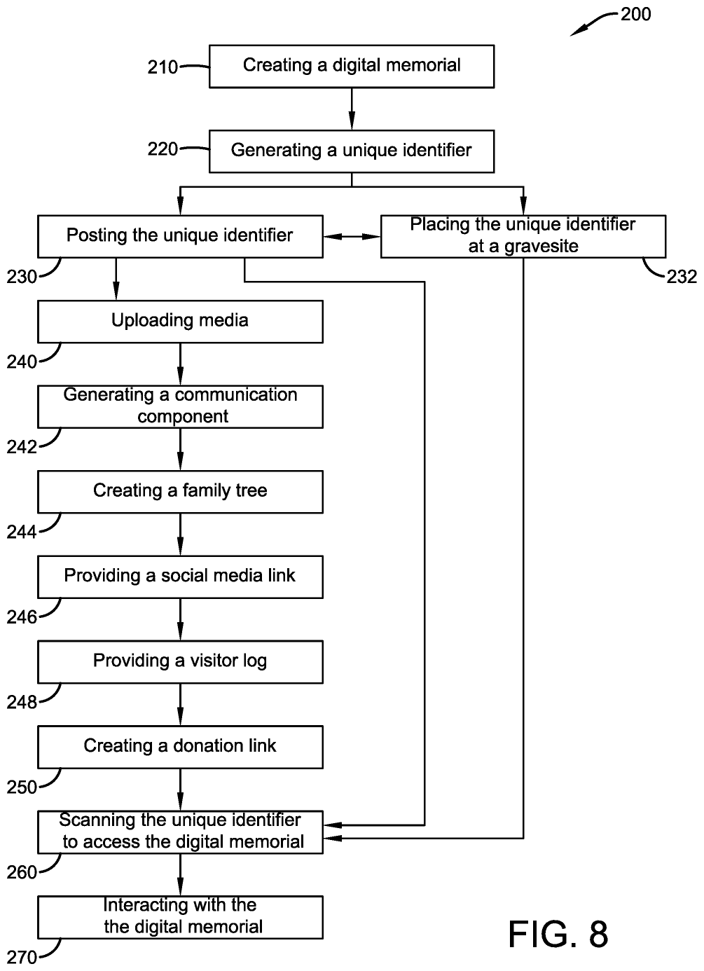

The subject matter disclosed and claimed herein, in another embodiment thereof, comprises a method 200 of memorializing a person using a commemorative system 100 as illustrated in FIG. 8. The commemorative system 100 comprises an interactive online memorial platform 140 hosted on a server 130. The online memorial platform 140 is accessible via a camera-equipped mobile electronic device 110 that connects to the online memorial platform 140 on the server 130 over a network 120. The method 200 is configured to memorialize a person in a platform that is remotely accessible over the Internet.

The method 200 comprises the step of creating a digital memorial 141 on the interactive online memorial platform 140 at 210. Next, a unique identifier 144 is generated specific to the digital memorial 141 at 220. The unique identifier 141 may be a QR code. The unique identifier 141 may be posted in print or digital media at 230 or may be integrated into a remote platform access component 170 that is positional at a grave site or other place of internment at 240.

Once the digital memorial 141 has been created at 210, it may be modified by the host or other user in the following manner. At 240, media such as pictures, video, or audio filed may be uploaded to the digital memorial 141. At 242, a communication component may be configured to allow users to interact publicly or privately. At 244, a family tree may be created, modified, or interacted with. At 246, a social media link may be provided to permit access to the decedent's social media sites. At 248, a visitor log may be provided to keep track of visitors and interaction with the digital memorial 141. At 250, a donation link may be provided to allow users to make a donation on behalf of the person being memorialized.

At any point after creation of the digital memorial 141, the unique identifier 144 is scanned using the camera-equipped mobile electronic device 114 to interact with the digital memorial 141 at 260. At 270, the user can interact with and access uploaded content related to the memorialized person hosted on the digital memorial 141. The user can also upload content related to the memorialized person to the digital memorial 141.

Notwithstanding the forgoing, the commemorative system 100 can by any configuration as is known in the art without affecting the overall concept of the invention, provided that it accomplishes the above stated objectives. One of ordinary skill in the art will appreciate that the commemorative system 100 and its various components, as show in the FIGS. are for illustrative purposes only, and that many other configurations of the commemorative system 100 are well within the scope of the present disclosure.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A commemorative system accessible via a mobile electronic device comprising:
a server comprising an online memorial platform and at least one processor operatively connectable to the mobile electronic device via a network: and
wherein the online memorial platform is configured to:
create a digital memorial memorializing a person;
generate a unique identifier specific to the digital memorial; and
allow a user to access the digital memorial by scanning the unique identifier with the mobile electronic device.

2. The commemorative system of claim 1, wherein the digital memorial is interactive.

3. The commemorative system of claim 1, wherein the digital memorial comprises a viewing component for displaying visual media.

4. The commemorative system of claim 1, wherein the digital memorial comprises at least one visual media upload component.

5. The commemorative system of claim 1, wherein the digital memorial comprises an audio upload component.

6. The commemorative system of claim 1, wherein the digital memorial comprises a family tree component.

7. The commemorative system of claim 1, wherein the digital memorial comprises a social media linking component.

8. The commemorative system of claim 1, wherein the digital memorial comprises at least one messaging component.

9. The commemorative system of claim 1 further comprising a remote platform access component configured to display the unique identifier at a grave site.

10. A non-transitory computer-readable medium comprising software instructions that, when executed by at least one processor, causes the processor to:
create a digital memorial memorializing a person;
generate a unique identifier specific to the digital memorial;
provide access to the digital memorial via the unique identifier; and
allow interaction with the digital memorial.

11. The non-transitory computer-readable medium of claim 10, wherein the digital memorial is accessible via a camera-equipped mobile electronic device configured to scan the unique identifier.

12. The non-transitory computer-readable medium of claim 10, wherein the unique identifier is a QR code.

13. The non-transitory computer-readable medium of claim 10, wherein the digital memorial comprises a private messaging component.

14. The non-transitory computer-readable medium of claim 10, wherein the digital memorial comprises a public messaging component.

15. The non-transitory computer-readable medium of claim 10, wherein the digital memorial comprises a visitor log component.

16. The non-transitory computer-readable medium of claim 10, wherein the digital memorial comprises a donation linking component.

17. A method of memorializing a person on an interactive online memorial platform using a mobile electronic device operatively connectable to the interactive online memorial platform over a network, the method comprising:
creating a digital memorial on the interactive online memorial platform;
generating a unique identifier for the digital memorial;
scanning the unique identifier using the mobile electronic device to access the digital memorial; and
interacting with the digital memorial.

18. The method of claim 17, wherein the unique identifier is a QR code.

19. The method of claim 17 further comprising the step of accessing uploaded content related to the memorialized person on the digital memorial.

20. The method of claim 17 further comprising the step of uploading content related to the memorialized person to the digital memorial.
